(19) United States
(12) Patent Application Publication
(10) Pub. No.: US 2004/0225836 A1
(43) Pub. Date: Nov. 11, 2004

(54) Portable USB storage device capable of being set to device mode or host mode

(75) Inventor: Che-Chung Lin, Taipei City (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsinchu (TW)

(21) Appl. No.: 10/747,115

(22) Filed: Dec. 30, 2003

(30) Foreign Application Priority Data
May 7, 2003 (TW) 092208361

(51) Int. Cl. G06F 12/00

(52) U.S. Cl. 711/115; 710/113

(57) ABSTRACT

A portable USB storage device is disclosed. The storage device comprises an USB interface coupled to an electronic device, a memory for storing data, an USB controller for controlling a reading/writing of the memory so that data is read from the memory to the electronic device or written into the memory from the electronic device, and a detector coupled to the USB interface for determining whether the electronic device is in a host mode or device mode. The detector will command the USB controller to either execute a device mode driver if the electronic device is determined to be in the host mode or execute a host mode driver if the electronic device is determined to be in a device mode.

### BACKGROUND OF THE INVENTION

1. Field of the Invention

The present invention relates to storage devices and, more particularly, to a portable USB storage device capable of being set to device mode or host mode.

2. Description of Related Art

Portable electronic devices (e.g., PDAs (Personal Digital Assistants), digital cameras, and notebook computers) are available in a more compact form while having enhanced data processing capability due to a rapid, spectacular development of electronics technology in recent years. For data transfer between a portable device (e.g., PDA) and a computer, a memory card or portable storage device (e.g., flash disk) is used recently. The flash disk is adapted to store data in a digital form. Also, the flash disk can be inserted into another electronic device so that the electronic device is able to read data from the flash disk.

The current flash disk has an USB interface for data transfer. Also, a typical digital camera provided with a memory has an USB interface adapted to couple to a computer for transferring digital data stored in the memory to the memory of the computer. The USB interface of the flash disk or digital camera is set as device mode in advance. Further, an electronic device (e.g., personal computer or PDA) has a USB interface set as host mode. This has the drawback of being inflexible in using USB interface. For example, a digital camera is unable to access data from a flash disk since both the digital camera and the flash disk are in device mode. Hence, a need for improvement exists in order to mitigate and/or obviate the aforementioned drawback.

### SUMMARY OF THE INVENTION

An object of the present invention is to provide a portable USB storage device capable of being set to device mode or host mode.

To achieve the above and other objects, the present invention provides a portable USB storage device, which comprises: an USB interface coupled to an electronic device; a memory for storing data; an USB controller for controlling a reading/writing of the memory so that data is read from the memory to the electronic device or written into the memory from the electronic device; and a detector coupled to the USB interface for determining whether the electronic device is in a host mode or device mode, wherein the detector commands the USB controller to execute a device mode driver if the electronic device is determined to be in the host mode or execute a host mode driver if the electronic device is determined to be in a device mode.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of the portable USB storage device in accordance with the invention;

FIG. 2 is a flowchart of the invention for determining whether a coupled electronic device is in a host mode or device mode; and

FIG. 3 is another flowchart of the invention for determining whether a coupled electronic device is in a host mode or device mode.

### DETAILED DESCRIPTION OF THE PREFERRED EMBODIMENT

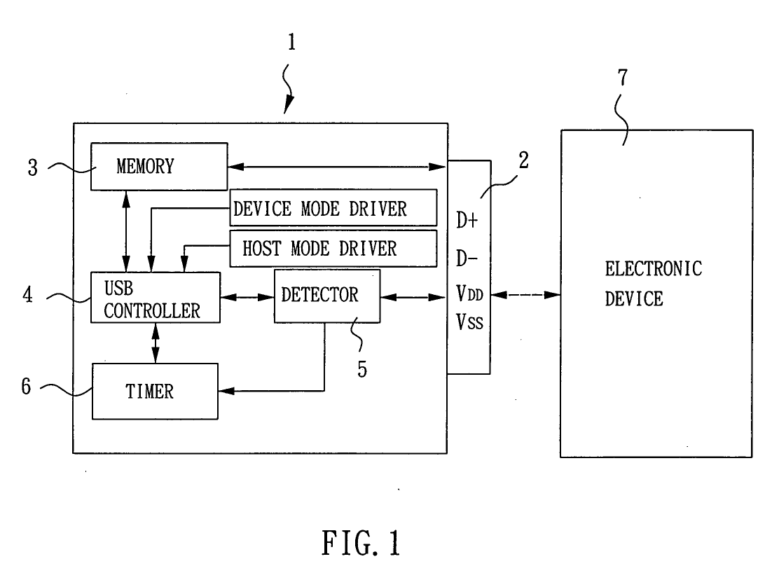

With reference to FIG. 1, there is shown a portable USB storage device 1 constructed in accordance with the invention, which comprises an USB interface 2, a memory 3, an USB controller 4, a detector 5, and a timer 6. Each component will be described in detail below.

The USB interface 2 is adapted to couple to an electronic device 7. In the embodiment, the electronic device 7 is a digital camera, a computer, a printer or a digital television set. The USB interface 2 is implemented as an USB connector. The memory 3 is adapted to store data in a digital form. In the embodiment, preferably the memory 3 is a nonvolatile memory (e.g., flash memory). The USB controller 4 is coupled to the memory 3 and the detector 5 respectively. The detector 5 is coupled to the USB interface 2. As such, the USB controller 4 is able to control a reading/writing of the memory 3. In detail, the USB controller 4 is able to control a data reading from the memory 3 to the electronic device 7 or data writing into the memory 3 from the electronic device 7.

The detector 5 is adapted to determine whether the electronic device 7 is in a host mode or device mode. The detector 5 will command the USB controller 4 to execute a device mode driver if the electronic device 7 is determined to be in the host mode. Otherwise, the detector 5 will command the USB controller 4 to execute a host mode driver (i.e., the electronic device 7 is determined to be in the device mode.)

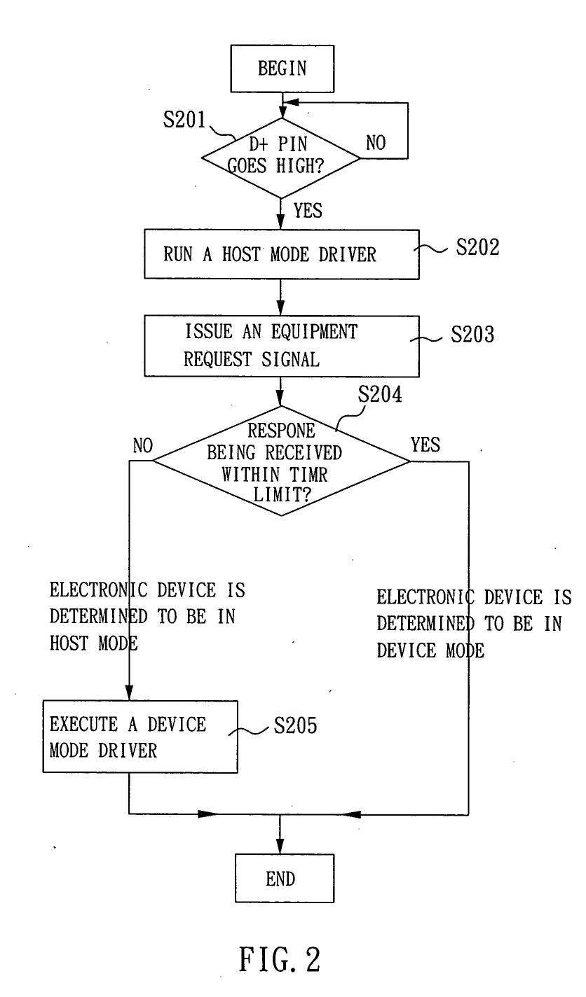

There are two methods of determining whether the electronic device 7 coupled to the portable storage device 1 is in a host mode or device mode by the detector 5. With reference to FIG. 2, there is shown a flowchart for the determination according to a first method of the invention. First, the USB interface 2 of the portable storage device 1 is required to couple to the electronic device 7. Thus, the flowchart begins in step S201 in which the detector 5 determines whether the USB interface 2 is coupled to the electronic device 7 by detecting whether the level of a D+ pin of the USB interface 2 goes high from low. Next, the detector 5 commands the USB controller 4 to run a host mode driver (step S202). Then, the detector 5 commands the USB interface 2 to issue an equipment request signal to the electronic device 7 (step S203). The electronic device 7 will respond immediately if the electronic device 7 is in the host mode according to the USB standard. A determination is then made whether there is a response from the electronic device 7 within a predetermined period of time (e.g., 20 ms) (step S204). If no, the detector 5 determines that the electronic device 7 is in the host mode. Next, the detector 5 commands the USB controller 4 to execute a device mode driver (step S205). Accordingly, the portable storage device 1 will be configured as in a device mode. If there is a response from the electronic device 7, the detector 5 determines that the electronic device 7 is in the device mode. Accordingly, the portable storage device 1 will be configured as in a host mode.

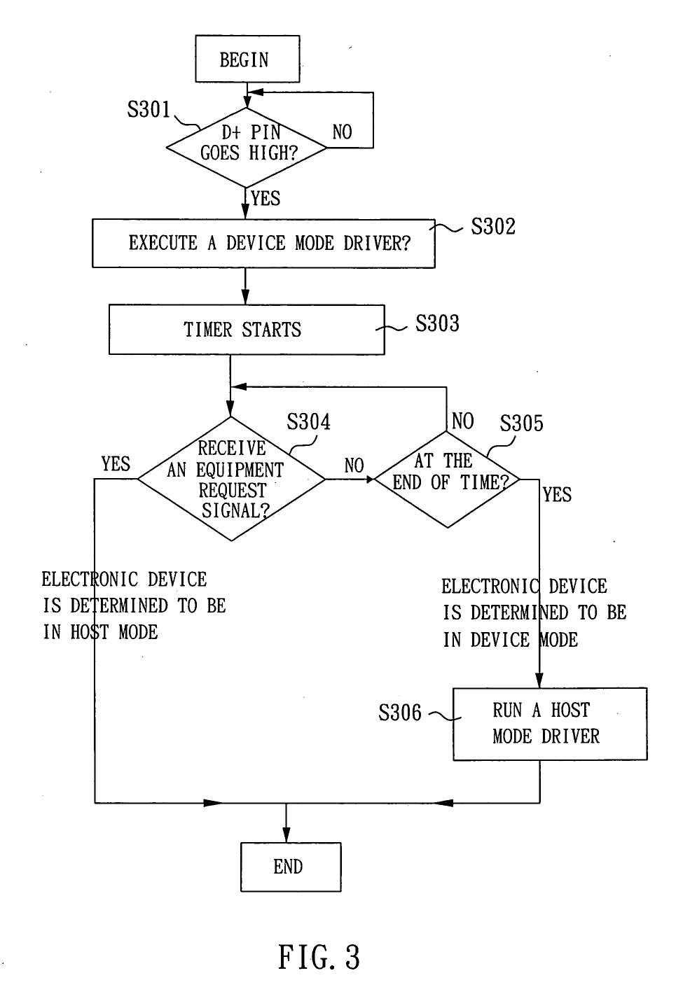

With reference to FIG. 3, there is shown a flowchart for the determination according to a second method of the invention. The flowchart begins in step S301 in which the detector 5 determines whether the USB interface 2 is coupled to the electronic device 7 by detecting whether the level of a D+ pin of the USB interface 2 goes high from low. Next, the detector 5 commands the USB controller 4 to execute a device mode driver (step S302). Then, the detector 5 commands the coupled timer 6 to start to count time (step S303). It is determined whether a response of an issued equipment request signal from the electronic device 7 has been received by the detector 5 at the end of time (steps S304 and S305). If no, the detector 5 determines that the electronic device 7 is in the device mode. Next, the detector 5 commands the USB controller 4 to execute a host mode driver (step S306). Accordingly, the portable storage device 1 will be configured as in a host mode. If the detector 5 receives the equipment request signal from the electronic device 7 before the end of time, the detector 5 determines that the electronic device 7 is in the host mode. Accordingly, the portable storage device 1 will be configured as in a device mode.

In view of foregoing, the invention configures an USB interface to couple to an electronic device. Also, a detector is adapted to detect whether the electronic device is in a host mode or device mode. The detector will command an USB controller to execute a device mode driver if the electronic device is determined to be in the host mode. Accordingly, the portable storage device will be configured as in the host mode. Otherwise, the detector will command the USB controller to execute a host mode driver (i.e., the electronic device is determined to be in the device mode). Accordingly, the portable storage device will be configured as in the device mode. This has the advantage of flexibly configuring a portable storage device to be adapted to a coupled electronic device via a USB interface.

Although the present invention has been explained in relation to its preferred embodiment, it is to be understood that many other possible modifications and variations can be made without departing from the spirit and scope of the invention as hereinafter claimed.

What is claimed is:

1. A portable USB storage device, comprising:
an USB interface coupled to an electronic device;
a memory for storing data;
an USB controller for controlling a reading/writing of the memory so that data is read from the memory to the electronic device or written into the memory from the electronic device; and
a detector coupled to the USB interface for determining whether the electronic device is in a host mode or device mode,
wherein the detector commands the USB controller to execute a device mode driver if the electronic device is determined to be in the host mode or execute a host mode driver if the electronic device is determined to be in a device mode.

2. The portable USB storage device as claimed in claim 1, wherein responsive to connecting the USB interface to the electronic device, the detector commands the USB interface to issue an equipment request signal to the electronic device, and the electronic device determines that the electronic device is in the host mode if there is no response from the electronic device within a predetermined period of time or determines that the electronic device is in the device mode if there is response from the electronic device within the predetermined period of time.

3. The portable USB storage device as claimed in claim 2, wherein the detector is operative to determine that the USB interface is coupled to the electronic device by detecting that the level of a D+ pin of the USB interface goes high from low.

4. The portable USB storage device as claimed in claim 2, wherein responsive to connecting the USB interface to the electronic device, the detector commands the USB controller to execute the host mode driver and commands the USB interface to issue an equipment request signal to the electronic device.

5. The portable USB storage device as claimed in claim 1, wherein responsive to connecting the USB interface to the electronic device, the detector commands a timer to count time, and it is determines that the electronic device is in the device mode if no response of the issued equipment request signal is received from the electronic device at the end of time; otherwise, it is determines that the electronic device is in the host mode.

6. The portable USB storage device as claimed in claim 5, wherein the detector is operative to determine that the USB interface is coupled to the electronic device by detecting that the level of a D+ pin of the USB interface goes high from low.

7. The portable USB storage device as claimed in claim 5, wherein responsive to connecting the USB interface to the electronic device, the detector commands the USB controller to execute the device mode driver for receiving the equipment request signal.

8. The portable USB storage device as claimed in claim 1, wherein the memory is a nonvolatile memory.

9. The portable USB storage device as claimed in claim 8, wherein the nonvolatile memory is a flash memory.

10. The portable USB storage device as claimed in claim 1, wherein the electronic device is a digital camera.

11. The portable USB storage device as claimed in claim 1, wherein the electronic device is a computer.

12. The portable USB storage device as claimed in claim 1, wherein the electronic device is a printer.

13. The portable USB storage device as claimed in claim 1, wherein the electronic device is a digital television set.
